(19) United States
(12) Patent Application Publication
(10) Pub. No.: US 2009/0021871 A1
(43) Pub. Date: Jan. 22, 2009

(54) Energy Storage Pack Having Overvoltage Protection and Method of Protection

(75) Inventors: Brian D. Moran, La Mesa, CA (US); Michael D. Wilk, Temecula, CA (US)

Correspondence Address: PROCOPIO, CORY, HARGREAVES & SAVITCH LLP, 530 B STREET, SUITE 2100, SAN DIEGO, CA, 92101, US

(73) Assignee: ISE CORPORATION, Poway, CA (US)

(21) Appl. No.: 12/237,529

(22) Filed: Sep. 25, 2008

Related U.S. Application Data
(63) Continuation-in-part of application No. 11/946,143, filed on Nov. 28, 2007.
Application No. 11/946,143 is a continuation-in-part of application No. 11/469,337, filed on Aug. 31, 2006.
Application No. 11/469,337 is a continuation-in-part of application No. 11/460,738, filed on Jul. 28, 2006.
Application No. 11/460,738 is a continuation of application No. 10/720,916, filed on Nov. 24, 2003, now Pat. No. 7,085,112.
Application No. 10/720,916 is a continuation-in-part of application No. 09/972,085, filed on Oct. 4, 2001, now Pat. No. 6,714,391.
Application No. 09/972,085 is a continuation-in-part of application No. 11/535,433, filed on Sep. 26, 2006.
Application No. 11/535,433 is a continuation-in-part of application No. 11/459,754, filed on Jul. 25, 2006.
Application No. 11/459,754 is a continuation-in-part of application No. 10/951,697, filed on Sep. 29, 2004, now Pat. No. 7,274,421.
Application No. 10/951,697 is a continuation-in-part of application No. 10/720,916, filed on Nov. 24, 2003, now Pat. No. 7,085,112.
Application No. 10/720,916 is a continuation-in-part of application No. 09/972,085, filed on Oct. 4, 2001, now Pat. No. 6,714,391.

(51) Int. Cl. H02H 7/16; H02H 3/20

(52) U.S. Cl. 361/15; 361/86; 903/907; 903/943

(57) ABSTRACT

An energy storage pack specially adapted for a hybrid electric vehicle, the energy storage pack having overvoltage protection and a method of protecting the same. In particular, the energy storage pack includes a robust, low-cost, parasitic circuit configured to detect overvoltage conditions within the vehicle energy storage and report it to the vehicle.

### CROSS-REFERENCE TO RELATED APPLICATIONS

This patent application is a continuation-in-part application of U.S. patent application Ser. No. 11/946,143, filed Nov. 28, 2007, which is a continuation-in-part of U.S. patent application Ser. No. 11/469,337, filed Aug. 31, 2006, which is a continuation-in-part of U.S. patent application Ser. No. 11/460,738, filed Jul. 28, 2006, which is a continuation of U.S. patent application Ser. No. 10/720,916, filed Nov. 24, 2003, issued as U.S. Pat. No. 7,085,112 on Aug. 1, 2006, which is a continuation-in-part application of U.S. patent application Ser. No. 09/972,085, filed Oct. 4, 2001, issued as U.S. Pat. No. 6,714,391 on Mar. 30, 2004. This patent application is also a continuation-in-part application of U.S. patent application Ser. No. 11/535,433, filed Sep. 26, 2006, which is a continuation-in-part application of U.S. patent application Ser. No. 11/459,754 filed Jul. 25, 2006, which is a continuation-in-part application of U.S. patent application Ser. No. 10/951,671 filed Sep. 28, 2004, which is a continuation-in-part application of U.S. patent application Ser. No. 10/720,916 filed Nov. 24, 2003, which is a continuation-in-part application of U.S. patent application Ser. No. 09/972,085 filed Oct. 4, 2001, now U.S. Pat. No. 6,714,391. These applications/patents are incorporated by reference herein as though set forth in full.

### FIELD OF THE INVENTION

The field of the invention relates to hybrid electric vehicles (HEVs) and high power electric drive systems. In particular, the field of the invention relates to components specially adapted for HEVs.

### BACKGROUND OF THE INVENTION

A hybrid electric vehicle (HEV) is a vehicle which combines a conventional propulsion system with an on-board rechargeable energy storage system to achieve better fuel economy and cleaner emissions than a conventional vehicle. While HEVs are commonly associated with automobiles, heavy-duty hybrids also exist. In the U.S., a heavy-duty vehicle is legally defined as having a gross weight of over 8,500 lbs. A heavy-duty HEV will typically have a gross weight of over 10,000 lbs. and may include vehicles such as a metropolitan transit bus, a refuse collection truck, a semi tractor trailer, etc.

In a parallel configuration (not shown), an HEV will commonly use an internal combustion engine (ICE) provide mechanical power to the drive wheels and to generate electrical energy. The electrical energy is stored in an energy storage device, such as a battery pack or an ultracapacitor pack, and may be used to assist the drive wheels as needed, for example during acceleration.

Referring to FIG. 1, in a series configuration, an HEV drive system 100 will commonly use an energy generation source such as an “engine genset” 110 comprising an engine 112 (e.g., ICE, H-ICE, CNG, LNG, etc.) coupled to a generator 114, and an energy storage pack 120 (e.g., battery, ultracapacitor, flywheel, etc.) to provide electric propulsion power to its drive wheel propulsion assembly 130. In particular, the engine 112 (here illustrated as an ICE) will drive generator 114, which will generate electricity to power one or more electric propulsion motor(s) 134 and/or charge the energy storage 120. Energy storage 120 may solely power the one or more electric propulsion motor(s) 134 or may augment power provided by the engine genset 110. Multiple electric propulsion motor(s) 134 may be mechanically coupled via a combining gearbox 133 to provide increased aggregate torque to the drive wheel assembly 132 or increased reliability. Heavy-duty HEVs may operate off a high voltage electrical power system rated at over 500 VDC. Propulsion motor(s) 134 for heavy-duty vehicles (here, having a gross weight of over 10,000) may include two AC induction motors that produce 85 kW of power (×2) and having a rated DC voltage of 650 VDC.

Unlike lower rated systems, heavy-duty high power HEV drive system components may also generate substantial amounts of heat. Due to the high temperatures generated, high power electronic components such as the generator 114 and electric propulsion motor(s) 134 will typically be cooled (e.g., water-glycol cooled), and may also be included in the same cooling loop as the ICE 112.

Since the HEV drive system 100 may include multiple energy sources (i.e., engine genset 110, energy storage device 120, and drive wheel propulsion assembly 130 in regeneration, which is discussed below), in order to freely communicate power, these energy sources may then be electrically coupled to a power bus, in particular a DC high power bus 150. In this way, energy can be transferred between components of the high power hybrid drive system as needed.

An HEV may further include both AC and DC high power systems. For example, the drive system 100 may generate, and run on, high power AC, but it may also convert it to DC for storage and/or transfer between components across the DC high power bus 150. Accordingly, the current may be converted via an inverter/rectifier 116, 136 or other suitable device (hereinafter “inverters” or “AC-DC converters”). Inverters 116, 136 for heavy-duty vehicles (i.e., having a gross weight of over 10,000) are costly, specialized components, which may include a special high frequency (e.g., 2-10 kHz) IGBT multiple phase water-glycol cooled inverter with a rated DC voltage of 650 VDC and having a peak current of 300 A.

As illustrated, HEV drive system 100 includes a first inverter 116 interspersed between the generator 114 and the DC high power bus 150, and a second inverter 136 interspersed between the generator 134 and the DC high power bus 150. Here the inverters 116, 136 are shown as separate devices, however it is understood that their functionality can be incorporated into a single unit.

As a key added feature of HEV efficiency, many HEVs recapture the kinetic energy of the vehicle via regenerative braking rather than dissipating kinetic energy via friction braking. In particular, regenerative braking (“regen”) is where the electric propulsion motor(s) 134 are switched to operate as generators, and a reverse torque is applied to the drive wheel assembly 132. In this process, the vehicle is slowed down by the main drive motor(s) 134, which converts the vehicle's kinetic energy to electrical energy. As the vehicle transfers its kinetic energy to the motor(s) 134, now operating as a generator(s), the vehicle slows and electricity is generated and stored. When the vehicle needs this stored energy for acceleration or other power needs, it is released by the energy storage 120.

This is particularly valuable for vehicles whose drive cycles include a significant amount of stopping and acceleration (e.g., metropolitan transit buses). Regenerative braking may also incorporated into an all-electric vehicle (EV) thereby providing a source of electricity generation onboard the vehicle.

When the energy storage 120 reaches a predetermined capacity (e.g., fully charged), the drive wheel propulsion assembly 130 may continue to operate in regen for efficient braking. However, instead of storing the energy generated, any additional regenerated electricity may be dissipated through a resistive braking resistor 140. Typically, the braking resistor 140 will be included in the cooling loop of the ICE 112, and will dissipate the excess energy as heat.

Focusing on the vehicle's energy storage, the energy storage pack 120 may be made up of a plurality of energy storage cells 122. The plurality of energy storage cells 122 may be electrically coupled in series, increasing the packs voltage. Alternately, energy storage cells 122 may be electrically coupled in parallel, increasing the packs current, or both in series and parallel.

When an energy storage cell (e.g., an ultracapacitor) is faulty or damaged it may have an increased equivalent series resistance (ESR). In this situation, if the pack continues to deliver/receive the same current, the voltage across the failed ultracapacitor will increase. This increased voltage may cause further deterioration and lead to poor performance and increased ESR across the bad cell. Ultimately the cell may fail all together. A complete failure may then lead to the loss of the entire energy storage pack and catastrophic loss to the vehicle.

### SUMMARY OF THE INVENTION

Accordingly, to protect against faults and failures growing unchecked within an energy storage pack, the inventors have discovered a robust, low-cost, self-sustaining circuit to detect overvoltage conditions within the vehicle energy storage and report it to the vehicle. Accordingly, an aspect of the invention involves an energy storage pack specially adapted for a hybrid electric vehicle, the energy storage pack having overvoltage protection and a method of protecting the same. Through early detection and reporting, the pack damage may then be prevented.

The energy storage pack specially adapted for a hybrid electric vehicle has a plurality of energy storage cells grouped into strings, with each of the strings having a string positive node and a string negative node. The pack also has an electrical interface with the hybrid electric vehicle that is electrically coupled to the strings and configured to deliver power to and from the vehicle. The energy storage pack is able to communicate directly with the hybrid vehicle using a vehicle communication interface that is coupled to an energy storage pack communication bus. The specially adapted pack further includes a plurality of overvoltage protection circuits, each singularly electrically coupled to a string, and communicatively coupled to the pack communication bus. Each of the overvoltage circuits registers voltage across it's respective string's string positive and negative node, and communicates an overvoltage condition to the energy storage pack communication bus, which is then passed on to the vehicle. The overvoltage circuits may be powered directly from the string such that an independent low voltage (e.g., 24 VDC) power supply is not required.

The method for protecting an energy storage pack includes detecting an overvoltage condition across at least one of a plurality of strings with reference to a predetermined trigger voltage, switching an on/off device in response to the detecting the overvoltage condition, and communicating the overvoltage condition to the vehicle communication bus in response to the switching the on/off device. The communication may be persistent and/or digitized and communicated according to the vehicle's communication bus protocol. The method, as well as the pack, may include embodiments where the communications may be overridden or otherwise reset. Alternately, the communication of the overvoltage condition may be visually communicated to a user, in addition to being communicated to the vehicle.

The foregoing description has outlined, rather broadly, preferred and alternative features of the present invention so that those skilled in the art may better understand the detailed description of the invention that follows. Additional features of the invention will be described hereinafter that form the subject matter of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention in its broadest form.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 illustrates drive components of a hybrid electric vehicle in a series configuration;

FIG. 2 is a functional schematic conceptually illustrating one embodiment of the invention;

FIG. 3 illustrates a more detailed view of an embodiment of the overvoltage protection circuitry; and

FIG. 4 illustrates an embodiment of an energy storage pack having a network of overvoltage protection circuits.

FIG. 5 illustrates an exemplary method for protecting an energy storage pack specially adapted for a hybrid electric vehicle.

FIG. 6 illustrates an exemplary method for protecting an energy storage pack specially adapted for a hybrid electric vehicle.

FIG. 7 illustrates an exemplary method for protecting an energy storage pack specially adapted for a hybrid electric vehicle.

FIG. 8 illustrates an exemplary method for communicating an overvoltage condition to a user.

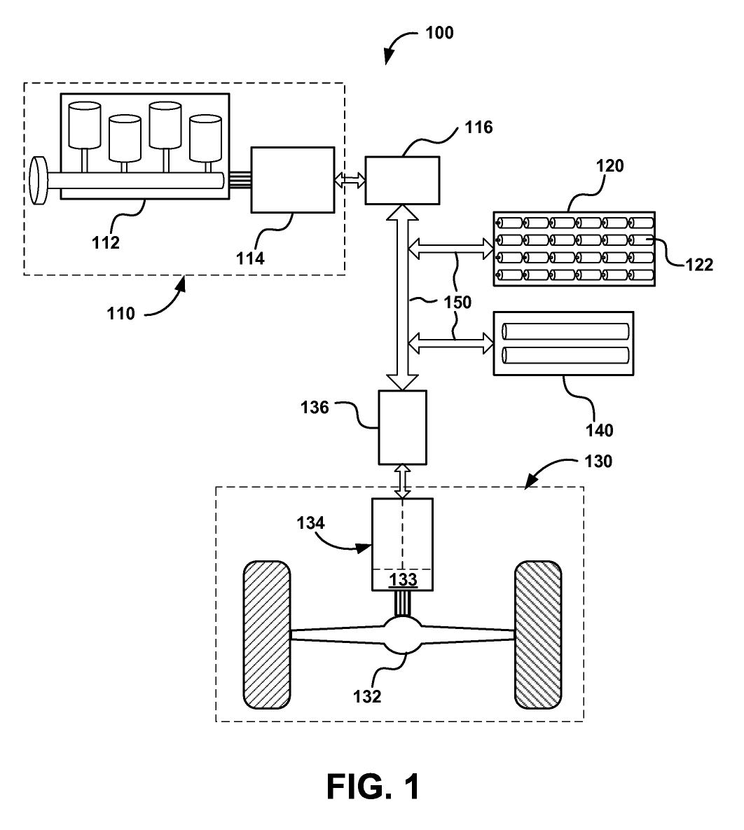

### DETAILED DESCRIPTION OF THE PREFERRED EMBODIMENT

The following discussion describes in detail an embodiment of the invention (and several variations of that embodiment). This description should not be construed, however, as limiting the invention to those particular embodiments, practitioners skilled in the art will recognize numerous other embodiments as well. For definition of the complete scope of the invention, the reader is directed to appended claims.

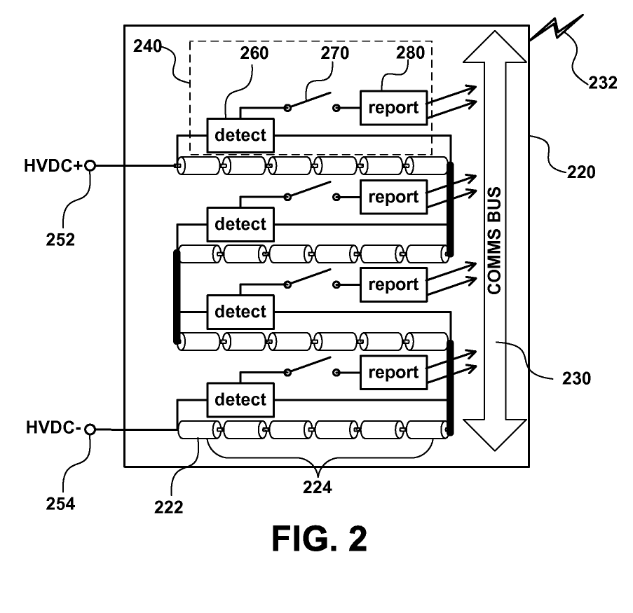

Referring now to FIG. 2, there is seen a functional schematic conceptually illustrating one embodiment of the invention. In particular, energy storage pack 220 is shown comprising a plurality of energy storage cells 222 electrically coupled in series, a communications bus 230, a communication interface 232 with the vehicle, a “positive” high voltage DC terminal 252 electrically coupled to the “high” side of the plurality of energy storage cells 222, and a “negative” high voltage DC terminal 254 electrically coupled to the “low” side of the plurality of energy storage cells 222. Within energy storage pack 220 the plurality of energy storage cells 222 are shown conveniently grouped in strings 224 of energy storage cells 222 wherein each string 224 has its own overvoltage protection circuitry 240.

Overvoltage protection circuitry 240 may include detection circuitry 260, on/off circuitry 270, and reporting circuitry 280. In operation, the overvoltage protection circuitry 240 will detect an overvoltage condition, trigger an on/off device, and report the overvoltage condition to the vehicle. It is understood that, while overvoltage protection circuitry 240 is conveniently illustrated as discrete elements (260, 270, 280) to aid in understanding the concept of the invention, this exemplary configuration is not limiting. For example, circuitry elements 260, 270, 280 may utilize shared components, or may be considered as a combination including the components illustrated.

It is further understood that although string 224 is illustrated as including six energy storage cells 222, this is merely one exemplary embodiment, and is no way limiting. Rather, the number of energy storage cells 222 may vary from application to application. For example, at one extreme, an energy storage pack 220 may have overvoltage protection that utilizes a circuit that compares a voltage across the entire energy storage pack 220 (i.e., a single string of all the cells) to a threshold voltage, setting an alarm if the measured voltage exceeds the threshold. However, in a heavy-duty HEV application for example, there may be 288 ultracapacitors within an ultracapacitor pack. This could create the onerous task of setting the threshold trigger condition such that a propagation of underperforming cells does not trigger a false alarm.

At the other extreme, an energy storage pack 220 may have overvoltage protection that utilizes circuitry that compares a voltage across each cell to a threshold voltage (i.e., groups of one-cell-each), and again, setting an alarm if the measured voltage exceeds the threshold voltage. While this may provide the highest accuracy, thus mitigating the problem of false alarms, it may unduly increase the complexity and cost of the system.

According to one preferred embodiment, the energy storage pack may include a plurality of ultracapacitor cells. Ultracapacitors (or supercapacitors) are a relatively new type of energy storage device that can be used in electric and hybrid-electric vehicles, either to replace or to supplement conventional chemical batteries. Ultracapacitors are electrochemical capacitors that have an unusually high energy density when compared to common capacitors, typically on the order of thousands of times greater than a high-capacity electrolytic capacitor. For instance, a typical D-cell sized electrolytic capacitor will have a storage capacity measured in microfarads, while the same size electric double-layer capacitor would store several farads, an improvement of about four orders of magnitude in capacitance, but usually at a lower working voltage. Larger commercial electric double-layer capacitors have capacities as high as 5,000 farads. Moreover, Ultracapacitors can store and release large amounts of power very rapidly, making them ideal for absorbing the electrical energy produced by electric and hybrid-electric vehicles during regenerative braking. This process may recapture up to 25% of the electrical energy used by such vehicles.

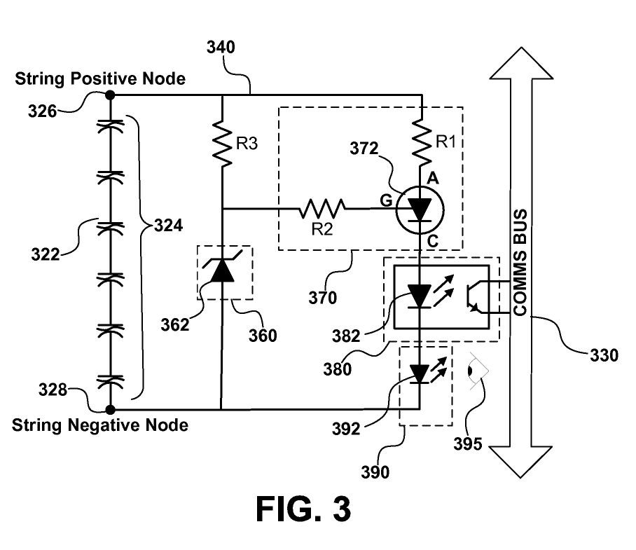

Referring now to FIG. 3, illustrated is a more detailed view of one embodiment of the overvoltage protection circuitry 340 (240 in FIG. 2). As illustrated, several ultracapacitors 322 are grouped together to form a string 324. As discussed above there is no set cell number requirement for string 324. Rather, the number of ultracapacitors may vary from application to application. For example, in one particular heavy-duty hybrid drive application, involving a metropolitan transit bus having certain performance requirements and wherein the ultracapacitor pack had 288 cells, the inventor has found it advantageous to break the cells into 48 strings of 6 cells each.

In the HEV application discussed above, having 288 cells, 2.7 VDC ultracapacitors may be used. Accordingly, the entire energy storage pack may be nominally rated at 750 VDC, and having a current of approximately 300 A. It should be appreciated that energy storage packs of heavy-duty vehicles may differ threefold from automobile-class HEVs (having a 240 VDC energy storage). At this magnitude, high power problems unique to heavy-duty vehicles may arise, and specialized components are typically required. For example, a failed cell may risk exposure to a full 750 VDC open-circuit voltage, frying most conventional components. In contrast, smaller vehicles may be sufficiently protected with conventional means and/or circuitry external to the pack, making it unnecessary to intervene within the pack and within the ultracapacitor strings themselves. Thus, overvoltage protection circuitry 340 is particularly useful in applications wherein the energy storage pack has a rated voltage of at least 500 VDC.

Continuing with FIG. 3, string 324 may include a string positive node 326 and a string negative node 328, in which overvoltage protection circuitry 340 may interface with the string 324. Overvoltage protection circuitry 340 may include detection circuitry 360, on/off circuitry 370, and reporting circuitry 380. Here, and throughout this disclosure, circuitry may be implemented as hardware, software, and/or a combination of both.

According to a preferred embodiment, overvoltage protection circuitry 340 may be a hardware solution. For example, detection circuitry 360 may include a voltage reference or voltage activated conductor that will conduct current once a predetermined triggering potential is reached across string positive node 326 and a string negative node 328. In particular, according to a preferred embodiment, detection circuitry 360 may include a Zener diode 362 (or an avalanche diode) electrically coupled as illustrated to string positive node 326 and string negative node 328, and in parallel with string 324, wherein the Zener diode 362 is configured to register voltage across string positive node 326 and a string negative node 328. A Zener diode is a type of diode that permits current to flow in the forward direction like a normal diode, but also in the reverse direction if the voltage is larger than the breakdown voltage. In this way, voltage may also be regulated at the breakdown voltage.

Under normal operating conditions the potential difference between string nodes 326 and 328 will be less than the trigger voltage of Zener 362. Accordingly, no current will flow through the Zener 362. Thus, prior to an overvoltage condition, no current will flow through detection circuitry 360. However, once an overvoltage condition occurs, Zener 362 will create a current path, which may be used to activate and power the overvoltage protection circuitry 340. Additionally, a resistor (R3) may be selected and positioned before Zener 362 so as to limit the current passing through the newly created current path.

According to one embodiment, reporting circuitry 380 may include an isolator that is electrically coupled to overvoltage protection circuitry 340 and communicatively coupled to ultracapacitor pack communications bus 330. In particular, according to a preferred embodiment, reporting circuitry 380 may include an opto-isolator 382 (or a galvanicisolator) electrically coupled to overvoltage protection circuitry 340 and optically coupled to ultracapacitor pack communications bus 330. An optoisolator (or optical isolator, optocoupler, photocoupler, or photoMOS) is a device that uses a short optical transmission path to transfer a signal between elements of a circuit, typically a transmitter and a receiver, while keeping them electrically isolated—since the signal goes from an electrical signal to an optical signal back to an electrical signal, electrical contact along the path is broken. Similarly, a galvanicisolator may be used such that there is no electrical current flowing directly from overvoltage protection circuitry 340 to ultracapacitor pack communications bus 330, while energy and/or information can still be exchanged between the sections by other means, however, such as by capacitance, induction, electromagnetic waves, optical, acoustic, or mechanical means. In this way signals associated with an overvoltage condition may be provided to the vehicle communication interface without exposing it to the vehicle's high voltage system.

According one embodiment, the overvoltage protection circuitry 340 may include on/off circuitry 370 that is configured to persistently communicate the overvoltage condition to the ultracapacitor pack communications bus 330 once the overvoltage condition occurs. This is in contrast to a communication that terminates once the overvoltage condition has returned below the threshold voltage. In particular, on/off circuitry 370 will remain off (e.g., “open”) while there is no overvoltage condition across string 324, but will turn on (e.g., “close”) and remain on once an overvoltage condition has occurred. Thus, overvoltage protection circuitry 340 may send a persistent signal that “remembers” that a failure occurred, which may have otherwise gone unnoticed and never realized. This is particularly beneficial where one cell has deteriorated enough that the string voltage is floating near the threshold voltage, yet does not remain out of spec for sufficient time to register the fault. Moreover, by being notified of an intermittent fault, this feature better aids vehicle maintenance personnel to prevent an oncoming failure in advance.

According to a preferred embodiment, on/off circuitry 370 may include a Programmable Unijunction Transistor (PUT) 372. A PUT behaves much like a unijunction transistor (UJT), but is “programmable” via external resistors (that is, you can use two resistors R1 & R2 to set a PUT's peak voltage). A PUT is a three-terminal thyristor that is triggered into conduction when the voltage at the anode exceeds the voltage at the gate. The PUT then remains in conduction, independent of gate voltage, until the current across the anode and cathode dips below the valley current—typically a nominal value. In a programmable unijunction transistor, operating characteristics such as base-to-base resistance, intrinsic standoff voltage, valley current, and peak current can be programmed by setting the values of two external resistors R1 and R2.

In operation herein, PUT 372 will trigger once the voltage at its anode is greater than at its gate. Under normal (untriggered) conditions Zener 362 and PUT 372 do not pass current. Accordingly, the voltage at PUT 372 anode and gate will be the same. At the overvoltage condition however, current begins to pass through Zener 362 and voltage difference can be realized. Note, as illustrated here, and with regard to resistance, R1<(R2+R3). Accordingly, once Zener 362 is fired, the voltage at the anode of PUT 372 will exceed its gate voltage and PUT 372 will turn on hard. At this point two things happen. First, optoisolator 382 will begin communicating the fault to the ultracapacitor pack communications bus 330. Second, PUT 372 will persist on until the current across it dips below the valley current. Thus, the PUT transistor 372 will be triggered when the Zener diode reaches its breakdown voltage and will allow the opto-isolator 382 to send, and continue to send, voltage-independent signals to the multiplexer, which can then be later used to indicate a fault condition in the ultracapacitor string 324 to the vehicle.

According to an alternate embodiment, on/off circuitry 370 may also include precautions against false triggers. Strategically placing a resistor R4 (not shown) between PUT 372 and string negative node 328, thus forming a resistor divider and bypassing optoisolator 382, reduces false triggers. The value of R4 will vary from application to application, however it should generally be on the order of R4=R1/((Vstring/(Vz+Vput))−1), where Vstring is the voltage across string 324, Vz is the breakdown voltage across the Zener 362, and Vput is the trigger voltage across the anode and the gate of PUT 372. This helps set voltage at the PUT 372 anode and resists false triggers.

This preferred embodiment provides several benefits. One benefit of this passive configuration is that overvoltage protection circuitry 340 does not require an external power supply, but rather is self-powered. In this way, overvoltage protection circuitry 340 is not subject to failure from a loss of external power. Moreover, overvoltage protection circuitry 340 will have operational power so long as the overvoltage condition exists. Similarly, this configuration reduces system complexity by obviating the need for external power supply circuitry. Another benefit of this passive configuration is that little or no power is consumed during normal operation. This is because overvoltage protection circuitry 340 “sees” the combination of Zener 362 and PUT 372 as configured as an open circuit. Only after a fault, does current pass. Advantages to using this hardware solution further include readily available standard parts, robustness, low cost, and ease of manufacture.

Another benefit of this preferred embodiment derives from the unique features of how an energy storage pack is operated within a vehicle having an electric drive system (e.g., an HEV). First, it should be understood by one skilled in the art that generally, these vehicles do not fully deplete their energy storage. Rather, most vehicles maintain a significant charge in the energy storage to avoid premature aging of the pack. Even with ultracapacitor packs, which can generally be discharged more than batteries without causing damage, useful work ceases before the pack has been fully discharged, and they are typically only fully discharged when the pack is being serviced (or the overall vehicle is being serviced). Therefore in an HEV-type application, the energy storage pack will still have sufficient power for the overvoltage protection circuitry 340 to continue to communicate the occurrence of the string/pack overvoltage condition, despite a general loss of useful power and/or a return to an acceptable string voltage (such as after the charge in the pack has been used up by the vehicle propulsion system).

According to one preferred embodiment, overvoltage protection circuitry 340 may further include a user interface 390 configured to communicate a signal indicative of the overvoltage condition to a user 395. In particular, according to a preferred embodiment, user interface 390 may include a LED (or other visual indicator) 392 electrically coupled as illustrated to the current path formed once on/off circuitry 370 enters the “on” state. In this way, maintenance personnel may quickly and efficiently identify a faulty string 324 at the energy storage pack component level, independent of an indication from the vehicle. User interface 390 may reside external to the pack (e.g., an LCD or LEDs fastened to the case of the pack), or internal to the pack (e.g., LEDs integrated into a PCB forming overvoltage protection circuitry 340).

According to one embodiment, the energy storage pack in which overvoltage protection circuitry 340 resides may include a visual access port wherein maintenance personnel may inspect for failures while the energy storage pack remains intact and/or installed on the vehicle. It is a safe practice to completely discharge the energy storage pack prior to maintenance. However, as discussed above, a full discharge will also remove overvoltage protection circuitry's 340 (and thus LED 392) power supply. With a visual access port, for example a plexiglass slot in the pack housing, LED 392 may be conveniently integrated into a PCB forming overvoltage protection circuitry 340 while still providing for easy and safe inspection. Thus, this embodiment obviates the need to open the pack for inspection prior to fully discharging the cells 322.

According to one embodiment, overvoltage protection circuitry 340 may further include a reset feature (not shown). In particular, overvoltage protection circuitry 340 may be configured to receive an override control signal, and in response, to terminate the persistent communication of the overvoltage condition. The override control signal may be manually or automatically provided. For example, once it is noted that the overvoltage condition has occurred, the overvoltage protection circuitry 340 may be reset to detect new overvoltage events. The signal may originate from a user proximate the vehicle, a remote user (e.g., via a remote diagnostic or telemetry system), and/or by the vehicle or pack itself (e.g., upon recording data associated with the overvoltage event). Also, in an embodiment where PUT 372 is used, the persistent communication may be overridden by inhibiting the current passing through. For example, this may be accomplished by interspersing a switch (or other on/off device) between PUT 372 and its current source. Alternately, the current may be bled off until the current entering PUT 372 is less than its valley current.

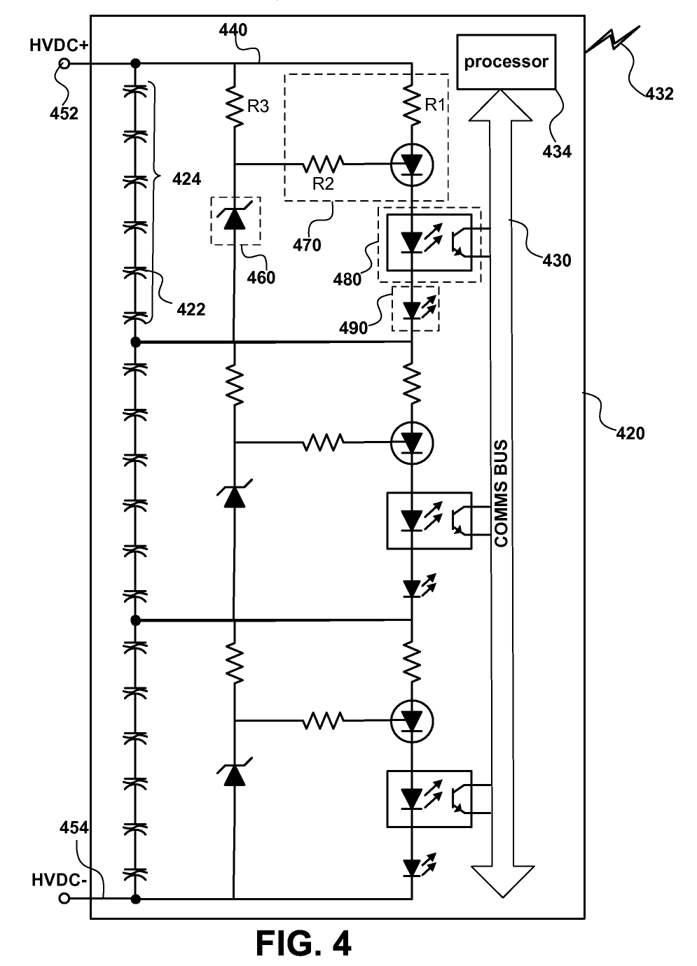

Referring now to FIG. 4, there is seen an energy storage pack having a network of overvoltage protection circuits 440. As described in greater detail above, overvoltage protection circuits 440 may interface with each string 424, and may include detection circuitry 460, on/off circuitry 470, reporting circuitry 480, and a user interface 490 (and/or their functional equivalents). In addition, energy storage pack 420 is shown comprising a plurality of energy storage cells 422 electrically coupled in series, a pack communications bus 430, a vehicle communication interface 432, a “positive” high voltage DC terminal 452 electrically coupled to the “high” side of the plurality of energy storage cells 422, and a “negative” high voltage DC terminal 454 electrically coupled to the “low” side of the plurality of energy storage cells 422. Within energy storage pack 420 the plurality of energy storage cells 422 are shown conveniently grouped in strings 424 of energy storage cells 422 wherein each string 424 has its own overvoltage protection circuitry 440.

According to one embodiment, the energy storage pack communications bus 430 may be configured such that all signals from each reporting circuitry 480 are multiplexed in. For example, energy storage pack communications bus 430 may include a single analog line, wherein a fault condition will send a simple binary signal that can be interpreted as an overvoltage event having occurred on at least one of the overvoltage protection circuits 440. Alternately, energy storage pack communications bus 430 may multiplex signals using a voltage divider (not shown), such that a final output from the energy storage pack (e.g., ultracapacitor pack) 420 can report a failure indicating the number of faulty strings 424. According to one preferred embodiment, all multiplexed signals can be digitized at discrete voltages such that a final output from the energy storage pack (e.g., ultracapacitor pack) can report a failure indicative of which string is bad.

According to another embodiment, energy storage pack 420 may also include a processor 434 configured to digitize (or modulate) signals communicated over the pack communications bus 430. For example, according to one embodiment, processor 434 may include a digital signal processor (DSP) configured to convert signals communicated over the pack communications bus 430 into bits of data in accordance with a standardized communication protocol. In this way communications over the energy storage communication bus 430 may be also communicated across vehicle communication interface 432 and multiplexed into a vehicle communication bus that uses the same protocol.

A vehicle communication bus is an electronic communications network that interconnects components inside an automobile, bus, industrial or agricultural vehicle, ship, or aircraft. Due to the specialized requirements of each type of deployment (including environmental constraints, cost, reliability and real-time characteristics), conventional computer networking technologies (such as Ethernet and TCP/IP) are rarely used. All cars sold in the United States since 1996 are required to have an On-Board Diagnostics connector, for easy access to the car's Controller Area Network (CAN) bus. A CAN bus is a computer network protocol and bus standard designed to allow microcontrollers and devices to communicate with each other without a host computer. There are several CAN communication standards used, which are tailored the vehicle application (e.g., ISO 11898, ISO 11992, ISO 11783, SAE J1939, SAE J2411).

By converting fault signals communicated by reporting circuitry 480 into a standardized, transportable format, energy storage pack 420 may then be seamlessly integrated into the vehicle's communication network. Fault signals indicating an overvoltage condition in the energy storage 420 may also be received and used by the Electric Vehicle Control Unit (EVCU) (or other control unit) in response to the condition, preempting a more severe event. Moreover, in a vehicle having telemetry equipment or remote diagnostic equipment, by now having access to the vehicle's communication bus, energy storage pack 420 may also communicate fault conditions remotely, off the vehicle, for remedial, diagnostic, and/or statistical analysis.

The energy storage pack described above, and all its equivalents, may provide earlier detection of fault/failure condition. It is easy to implement, having a low number of parts, and may provide increased protection to itself and to the vehicle in which it is installed.

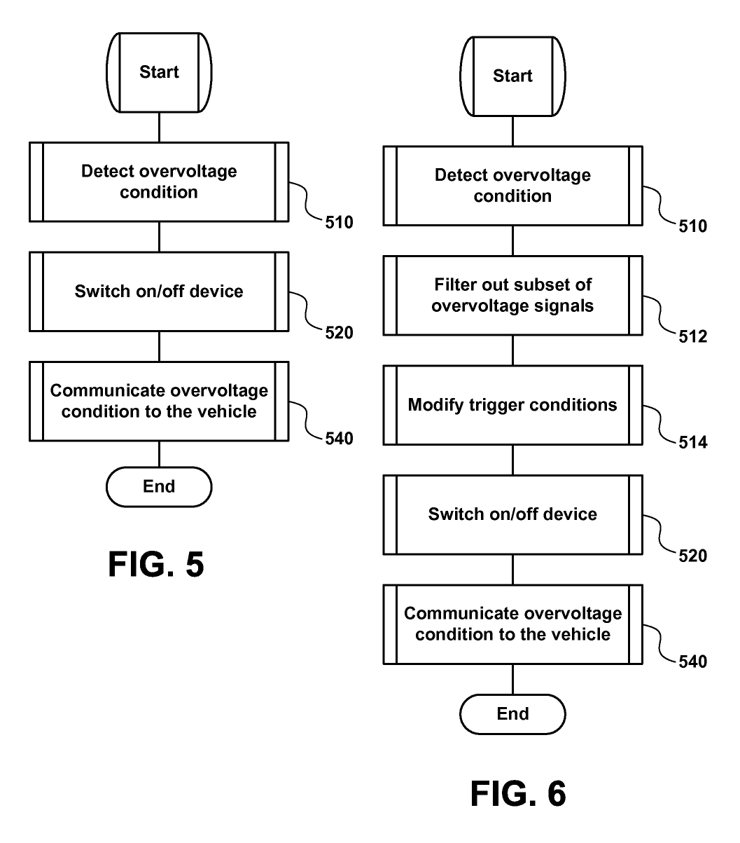

Referring now to FIG. 5, there is seen an exemplary method for protecting an energy storage pack specially adapted for a hybrid electric vehicle and communicatively coupled to a vehicle communication bus. According to one embodiment, the energy storage pack may have an integrated energy storage pack communication bus and include a plurality of energy storage cells grouped into a plurality of strings. It is understood the steps illustrated herein can be modified in a variety of ways without departing from the spirit and scope of the invention. For example, various portions of the illustrated processes can be combined, can be rearranged in an alternate sequence, can be removed, and the like.

The method generally begins by detecting an overvoltage condition across at least one of the plurality of energy storage cell strings at process 510. Once the overvoltage condition is detected, an on/off device may be switched 520 and the overvoltage condition may be communicated to the vehicle 540. Preferably, the overvoltage condition may be communicated to the vehicle 540 by first multiplexing a signal into the energy storage communications bus, and then communicating it to the vehicle communication bus via a vehicle communication interface. According to one embodiment, the overvoltage condition may be reported in response to the switching the on/off device, such that changing the state of the on/off device causes the overvoltage condition to be communicated to the vehicle 540.

Additionally, the on/off device may be a state device such that once its state is changed (e.g., switched “on”) it will persist in that state (e.g., will not turn “off”). In this way, communication of the overvoltage condition to the vehicle 540 may be done persistently. Moreover, persistently communicating the overvoltage condition to the vehicle communication bus may done independent of whether the overvoltage condition has terminated. In this way the method for protecting the energy storage pack may efficiently communicate and identify a fault/failure condition without risking it going unnoticed, and without needing to provide a separate memory device and recordation step.

In step 510, the overvoltage condition is detected with reference to a predetermined trigger conditions. For example, the trigger conditions may include the voltage across the string, as well as its duration. Trigger conditions may also include temperature. Preferably, the trigger conditions are selected in light of the vehicle's operating conditions and what the energy storage cell is likely to experience during its duty cycle so that false triggers are avoided. For example, where temperature is included, the temperature measured may be referenced against an independent temperature such as ambient temperature; or where voltage is measured, sampling may be used and/or modified upon the occurrence of an electrical event such as initiating braking regeneration. In this way the sensitivity of the detection 510 may be variable and adaptive to the vehicle's operation condition. According to one embodiment incorporating both temperature and voltage, detecting the overvoltage condition 510 may include recalibrating the overvoltage trigger depending on the system temperature. This flexibility is particularly important where a persistent signal is to be sent, since the signal generally will not reset itself.

Though extensive testing, it has been discovered that ultracapacitor pack cycling may result in wide voltage ranges across a string. This may be representative of a HEV operating in heavy regeneration immediately after depleting cell charge, for instance, when the vehicle passes the summit of a high grade road or shifts from acceleration to rapid deceleration. In this case, without the proper precautions, the method may falsely detect an overvoltage condition on each regeneration cycle.

Accordingly, the overvoltage condition detection 510 may include further precautions against being triggered by intermittent spikes or signals generally unrelated to a failed cell. In particular and referring to FIG. 6, the process of detecting the overvoltage condition may include filtering out overvoltage signals that are less likely to be indicative of a component fault 512, and/or increasing the threshold of the trigger conditions 514. For example, the dominant failure producing an overvoltage response is where the cell's Equivalent Series Resistance (ESR) has increased beyond its tolerance. This is considered a relatively static condition, and not likely to produce high frequency voltage fluctuations. Accordingly, in detecting the overvoltage condition 510, the method may include ignoring or filtering out temporary voltage spikes, wherein “temporary” is relative to the overvoltage duration characteristic of a faulty/failed cell. Preferably, a hardware implementation may be used. In particular, electronic components may be selected such that the transients are filtered out or otherwise dissipated. For example, series resistors and/or parallel capacitors may be used to filter or snub transients. In this way, unwanted transients may be blocked from falsely triggering an overvoltage condition.

Depending on how the string voltage is measured, voltage spikes associated with electronic noise may be inadvertently detected. In one case, when an electromechnical device like a switch closes, it often “bounces”—makes initial contact, springs back up breaking the contact, then eventually settles down in a closed state. The “bounce” may result in a false trigger. Accordingly, the method may filter out or “debounce” all those false make-break signals that can occur at the start of the switch closure. Debouncing can be performed in either hardware or software.

In a software implementation, debounce techniques may be used, and written in the software code. One software technique for debouncing that may be used is sampling. In particular, after a closure is detected, the method may include simply checking its state again 5 or 10 times with a few milliseconds delay between each check. Once the sample consistently indicates the overvoltage condition, it may be treated as such.

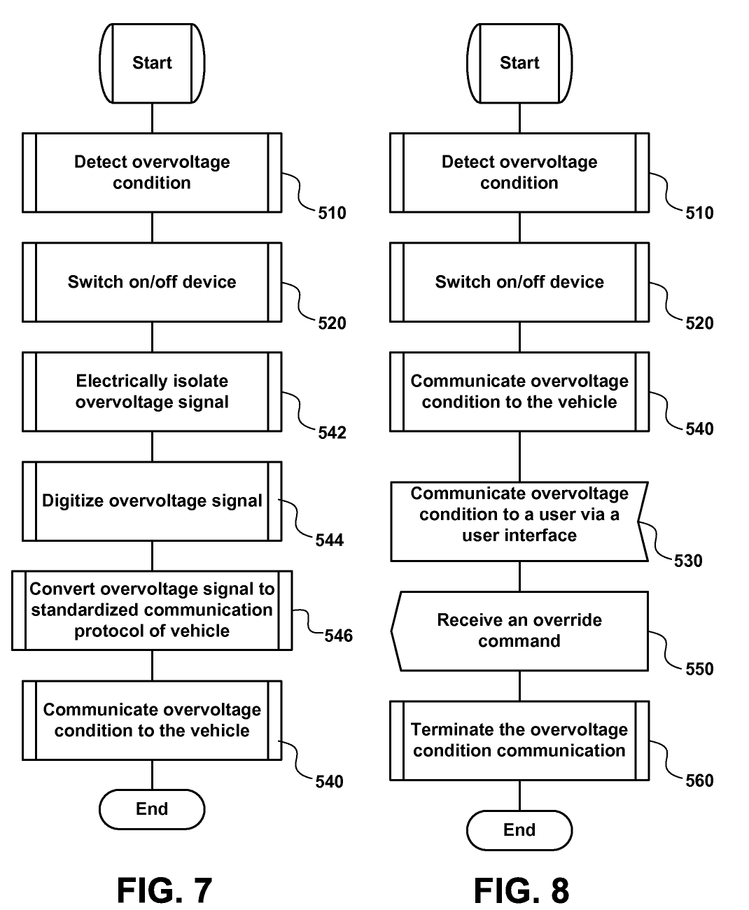

Referring to FIG. 7, according to one embodiment, the overvoltage condition may be communicated to the vehicle 540 using an isolated communication. An energy storage pack for a vehicle may see normal operating voltages on the order of 300-800 VDC, whereas a vehicle communication bus may typically operate on a 12 or 24 VDC system. Electronics may be used to limit the voltage of the communications, however, if the limiting circuitry fails, the vehicle communication system may be exposed to very high voltage from the energy storage pack. This could lead to catastrophic loss to the communication bus, to the components coupled to the vehicle communication bus, and to the control systems of the vehicle. Accordingly, the overvoltage signal may electrically isolated 542 before being communicated to the vehicle 540. An isolated communication may be achieved by using the isolator described above that is electrically coupled to overvoltage detection circuitry but only communicatively coupled to vehicle communication circuitry. In this way signals associated with an overvoltage condition may be communicated to the vehicle without exposing the vehicle to the high voltage of the energy storage.

Also as discussed above, the energy storage pack may communicate the overvoltage condition to the vehicle communication bus via an electrically isolated communication by first multiplexing an isolated signal into the energy storage communications bus, and then communicating it to the vehicle. This will allow any of the plurality of strings to report the fault efficiently, while only requiring a single communication interface with the vehicle.

Preferably, the method will also include digitizing communications 544 communicated over the energy storage pack communication bus; and converting the communications communicated over the energy storage pack communication bus according to a standardized communications protocol 546 associated with the vehicle communication bus. For example, the signals sent to the vehicle communication bus may be communicated according to a CAN protocol. In this way, the vehicle communication system can be used to broadly pass on data regarding the pack to controllers and systems onboard the vehicle. Also, the data can be transmitted off board the vehicle via telemetry and diagnostic systems for secondary control and analysis.

Referring to FIG. 8, the method may further include communicating the overvoltage condition to a user via a user interface 530. The user interface may be any perceivable means. For example, the user interface may be at least one LED as discussed above. Alternately, the user interface may be any other visual, aural, and/or tactile indicator the user may perceive.

As discussed above, the method may include persistently communicating the overvoltage condition to the vehicle, however where the overvoltage condition is communicated to a user 530, the method may advantageously further include receiving an override command 550 and terminating the overvoltage condition communication. For example, a fleet mechanic may inspect the energy storage pack at the end of a duty cycle, noting that an overvoltage condition has occurred by viewing an LED indicator on the pack itself, and reset the circuit by pressing a reset button, thus terminating the overvoltage condition communication 560.

Having thus described the invention by reference to alternate and preferred embodiments it is to be well understood that the embodiments in question are exemplary only and that modifications and variations such as will occur to those possessed of appropriate knowledge and skills may be made without departure from the spirit and scope of the invention as set forth in the appended claims and equivalents thereof.

What is claimed is:

1. An energy storage pack specially adapted for a hybrid electric vehicle, the energy storage pack comprising:
a plurality of energy storage cells grouped into a plurality of strings, each of the strings having a string positive node and a string negative node;
an electrical interface with the hybrid electric vehicle, the electrical interface with the hybrid electric vehicle electrically coupled to the plurality of energy storage cells grouped into the plurality of strings and configured to deliver electrical energy to and from the plurality of energy storage cells;
an energy storage pack communication bus;
a communication interface with the hybrid electric vehicle, the communication interface with the hybrid electric vehicle communicatively coupled to the energy storage pack communication bus;
a plurality of overvoltage protection circuits, each of the plurality of overvoltage protection circuits singularly electrically coupled to one of the plurality of strings and communicatively coupled to the energy storage pack communication bus, each of the plurality of overvoltage protection circuits configured to register voltage across it's respective string's string positive node and string negative node, and each of the plurality of overvoltage protection circuits further configured to communicate an overvoltage condition to the energy storage pack communication bus.

2. The energy storage pack of claim 1, wherein the plurality of energy storage cells comprises a plurality of ultracapacitors.

3. The energy storage pack of claim 1, wherein the energy storage pack has a rated voltage of at least 500 VDC.

4. The energy storage pack of claim 1, wherein each of the plurality of overvoltage protection circuits comprises an interface to its respective string positive node, an interface to its respective string negative node, a voltage reference electrically coupled to both its respective string positive node and its respective string negative node, an on/off device, and an isolator electrically coupled to the on/off device and communicatively multiplexed into the energy storage pack communication bus.
wherein the voltage reference is configured to register voltage across its respective string positive node and its respective string negative node; and,
wherein the on/off device is configured to persistently communicate the overvoltage condition to the energy storage pack communication bus.

5. The energy storage pack of claim 4, wherein the voltage reference comprises a Zener diode.

6. The energy storage pack of claim 4, wherein the voltage reference comprises an avalanche diode.

7. The energy storage pack of claim 4, wherein the on/off device comprises a programmable unijunction transistor.

8. The energy storage pack of claim 4, wherein the on/off device comprises a thyristor.

9. The energy storage pack of claim 4, wherein the isolator comprises an optoisolator.

10. The energy storage pack of claim 4, wherein the isolator comprises a galvanic isolator.

11. The energy storage pack of claim 1, wherein the hybrid electric vehicle includes a vehicle communication bus; and,
wherein energy storage pack communication bus is communicably coupled to the vehicle communication bus.

12. The energy storage pack of claim 1 further comprising a processor configured to digitize communications communicated over the energy storage pack communication bus.

13. The energy storage pack of claim 12, wherein the processor is further configured to communicate the communications communicated over the energy storage pack communication bus according to a standardized communications protocol associated with the vehicle communication bus.

14. The energy storage pack of claim 1, wherein each of the plurality of overvoltage protection circuits is further configured to persistently communicate the overvoltage condition to the energy storage pack communication bus independent of whether the overvoltage condition has terminated.

15. The energy storage pack of claim 14, wherein the overvoltage protection circuit is further configured to receive an override control signal, and in response, to terminate the persistent communication of the overvoltage condition.

16. The energy storage pack of claim 1, wherein each of the plurality of overvoltage protection circuits comprises an LED configured to emit upon the occurrence of the overvoltage condition.

17. A method for protecting an energy storage pack, the energy storage pack specially adapted for a hybrid electric vehicle, and communicatively coupled to a vehicle communication bus, the energy storage pack having an energy storage pack communication bus and a plurality of energy storage cells grouped into a plurality of strings, the method comprising:
detecting an overvoltage condition across at least one of the plurality of strings with reference to a predetermined trigger voltage;
switching an on/off device in response to the detecting the overvoltage condition; and,
communicating the overvoltage condition to the vehicle communication bus in response to the switching the on/off device.

18. The method of claim 17, wherein the communicating the overvoltage condition to the vehicle communication bus comprises communicating the overvoltage condition to the vehicle communication bus via an electrically isolated communication multiplexed into the energy storage pack communication bus.

19. The method of claim 17, wherein the communicating the overvoltage condition to the vehicle communication bus comprises:
digitizing communications communicated over the energy storage pack communication bus; and,
communicating the communications communicated over the energy storage pack communication bus according to a standardized communications protocol associated with the vehicle communication bus.

20. The method of claim 17, wherein the communicating the overvoltage condition to the vehicle communication bus comprises persistently communicating the overvoltage condition to the vehicle communication bus independent of whether the overvoltage condition has terminated.

21. The method of claim 20 further comprising:
receiving an override command; and,
terminating the persistently communicated overvoltage condition responsive to the receiving an override command.

22. The method of claim 20 further comprising persistently communicating a visual signal to a user, the visual signal indicative of the overvoltage condition and independent of whether the overvoltage condition has terminated.
